(19) United States
(12) Patent Application Publication
(10) Pub. No.: US 2017/0163925 A1
(43) Pub. Date: Jun. 8, 2017

(54) MASTER CONTROL DEVICE, PLAYING DEVICE AND DATA TRANSMISSION METHOD THEREBETWEEN

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Pengfei LI, Tianjin (CN)

(21) Appl. No.: 15/247,654

(22) Filed: Aug. 25, 2016

Related U.S. Application Data
(63) Continuation of application No. PCT/CN2016/089083, filed on Jul. 7, 2016.

(30) Foreign Application Priority Data
Dec. 4, 2015 (CN) 201510885410.3

(51) Int. Cl. H04N 5/44; H04N 21/41; H04N 21/4722

(52) U.S. Cl. CPC H04N 5/4403; H04N 21/4722; H04N 21/4126; H04N 2005/4407; H04N 2005/4425; H04N 2005/441

(57) ABSTRACT

The present disclosure discloses a master control device, a playing device and a data transmission method between the master control device and the playing device. The method includes the following steps: the master control device acquires other device connected in a local area network, and selects the playing device from the other device to establish a connection; receiving a first broadcasting message that is sent from the connected playing device, wherein the first broadcasting message is generated when the connected playing device determines that a display feedback condition is met, and includes program information that is currently displayed on the connected playing device; and displaying on the master control device the program information that is currently displayed on the connected playing device.

### CROSS-REFERENCE TO RELATED APPLICATIONS

The present disclosure is a continuation of International Application No. PCT/CN2016/089083 filed on Jul. 7, 2016, which is based upon and claims priority to Chinese Patent Application No. 201510885410.3, entitled “MASTER CONTROL DEVICE, PLAYING DEVICE AND DATA TRANSMISSION METHOD THEREBETWEEN”, filed Dec. 4, 2015, the entire contents of all of which are incorporated herein by reference.

### FIELD OF TECHNOLOGY

The present disclosure generally relates to the technical field of mobile Internet, in particular to a master control device, a playing device and a data transmission method between the master control device and the playing device.

### BACKGROUND

With the development of Internet, the mobile phone is a kind of handheld communication device that is most frequently used by people at present, and people have become accustomed to carrying mobile phones with them everywhere and putting their mobile phones nearby. Therefore, many people hope that the mobile phones can also be used as remote controllers for televisions. At present, software and hardware of smartphones have been very powerful, touch screens of large dimension can be designed as controllers of various keyboard layouts, so that the smartphones can be used as the remote controllers for televisions as long as appropriate software is matched with small accessories. Current mobile phone-based remote controllers only have a remote controlling function of conventional remote controllers.

### SUMMARY

According to an embodiment of the present disclosure, the technical problem to be solved is to provide a method for data transmission between a master control device and a playing device to solve the problem of a single function of a conventional remote controller.

Correspondingly, an embodiment of the present disclosure further discloses a master control device and a playing device to ensure the implementation and application of the above method.

To solve the problem above, an embodiment of the present disclosure discloses a data transmission method between a master control device and a playing device, the method including the following steps:

acquiring, by the master control device, other devices connected in a local area network, and selecting the playing device from the other devices to establish a connection;

receiving a first broadcasting message that is sent from the connected playing device, wherein the first broadcasting message is generated when the connected playing device determines that a display feedback condition is met, and the first broadcasting message comprises program information that is currently displayed on the connected playing device; and

displaying on the master control device the program information that is currently displayed on the connected playing device.

An embodiment of the present disclosure further discloses a data transmission method between a master control device and a playing device, the method including the following steps:

acquiring currently displayed program information when it is determined that a display feedback condition is met after the playing device and the master control device establish a connection;

employing the currently displayed program information to generate a first broadcasting message; and

sending the first broadcasting message to the connected master control device.

An embodiment of the present disclosure further discloses an electronic device, including at least one first processor; and a first memory communicably connected with the at least one first processor for storing instructions executable by the at least one first processor, wherein execution of the instructions by the at least one first processor causes the at least one first processor to:

acquire other devices connected in a local area network and select a playing device from the other devices to establish a connection;

receive a first broadcasting message that is sent from the connected playing device, wherein the first broadcasting message is generated when the connected playing device determines that a display feedback condition is met, and the first broadcasting message includes program information that is currently displayed on the connected playing device; and

display the program information that is currently displayed on the connected playing device.

An embodiment of the present disclosure further discloses an electronic device, including at least one second processor; and a second memory communicably connected with the at least one second processor for storing instructions executable by the at least one second processor, wherein execution of the instructions by the at least one second processor causes the at least one second processor to:

acquire currently displayed program information when it is determined that a display feedback condition is met after the electronic device and a master control device establish a connection;

employ the currently displayed program information to generate a first broadcasting message; and

send the first broadcasting message to the connected master control device.

An embodiment of the present disclosure discloses a computer program, including a computer readable code, which causes the master control device to execute the data transmission method above when operating on the master control device.

An embodiment of the present disclosure discloses a computer program, including a computer readable code, which cases the playing device to execute the data transmission method above when operating on the playing device.

An embodiment of the present disclosure discloses a computer readable medium, in which the computer program above is stored.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of realizing a data transmission method between a master control device and playing device at the master control device according to some embodiments of the present disclosure.

FIG. 2 is a step flowchart of realizing a data transmission method between a master control device and playing device at the playing device according to some embodiments of the present disclosure.

FIG. 3 is a step flowchart of realizing a data transmission method between a master control device and playing device as a whole according to some embodiments of the present disclosure.

FIG. 4 is a schematic diagram of a data transmission method according to some embodiments of the present disclosure.

FIG. 5 is a structural block diagram of a master control device according to some embodiments of the present disclosure.

FIG. 6 is a structural block diagram of another master control device according to some embodiments of the present disclosure.

FIG. 7 is a structural block diagram of playing device according to some embodiments of the present disclosure.

FIG. 8 is a structural block diagram of another playing device according to some embodiments of the present disclosure.

FIG. 9 is diagram of a data transmission system according to some embodiments of the present disclosure;

FIG. 10 schematically illustrates a block diagram of an electronic device for executing the method according to some embodiments of the present disclosure.

FIG. 11 schematically illustrates a memory cell used to keep or carry a program code for realizing the method according to some embodiments of the present disclosure.

### DETAILED DESCRIPTION

In order to clarify the objects, technical solutions and advantages of the embodiments of the present disclosure, the technical solutions in the embodiments of the present disclosure will be described in a clear and fully understandable way in connection with the drawings related to the embodiments of the present disclosure. It is obvious that the described embodiments are just a part but not all of the embodiments of the present disclosure. Based on the described embodiments herein, a person skilled in the art can obtain other embodiment(s), without any creative work, which should fall within the scope of the present disclosure.

According to the embodiment of the present disclosure, one of core concepts is to provide a master control device, a playing device and a data transmission method between the master control device and the playing device. Through a connection that is established between the master control device and the selected playing device, the playing device acquires currently displayed program information to generate a first broadcasting message and sends the first broadcasting message to the connected master control device, and the master control device displays the program information that is included in the first broadcasting message and is currently displayed on the playing device after receiving the first broadcasting message. A user can interact with content of a program that is currently displayed on the playing device by clicking the program information, so that functions of a mobile phone as a remote controller are enriched.

### First Embodiment

A data transmission method between a master control device and playing device according to an embodiment of the present disclosure will be described in detail. The embodiment mainly describes a processing process at the master control device.

With reference to FIG. 1, which illustrates a step flowchart of realizing a data transmission method between a master control device and a playing device at the master control device according to an embodiment of the present disclosure, the data transmission method may specifically include the steps as follows.

Step S102, the master control device acquires other devices connected in a local area network, and selects the playing device from the other devices to establish a connection.

The master control device includes a mobile phone and a tablet computer. Current master control device as remote controllers only has a remote control function of a conventional remote controller, quite a single function. As user's requirements become higher and higher, users not only hope that mobile phone-based remote controllers have the single remote control function of the conventional remote controllers, but also hope that the mobile phone-based remote controllers can bear more functions in connection with television content resources, so as to meet user's requirement for an interaction with the playing device through the master control device in a better manner.

According to an embodiment of the present disclosure, the local area network refers to a communication network that is formed by interconnecting various other devices such as the master control device, the playing device and the like in a local geographical range. If a network is established by means of a router in a household, the mobile phone, the tablet computer, the playing device, a notebook computer and the like that are connected to the router are all device on the same local area network. The respective device in the local area network may also be interconnected and intercommunicated. When the user hopes to realize a program content interaction with certain playing device through the master control device such as the mobile phone, the tablet computer and the like, the master control device is required to establish a connection with the playing device firstly. Therefore, the master control device is required to acquire other devices that is connected in the local area network and select the playing device from the other devices to establish the connection for the convenience of the subsequent program content interaction with the playing device through the master control device.

Step S104, receiving a first broadcasting message that is sent from the connected playing device, wherein the first broadcasting message is generated when the connected playing device determines that a display feedback condition is met, and the first broadcasting message includes program information that is currently displayed on the connected playing device.

Different pieces of device that are connected in the local area network are communicated with each other in a broadcast transmission manner, wherein the broadcast transmission refers to a broadcasting data package in an IP (Internet Protocol) sub-network, and all hosts in the sub-network will receive these data package. The broadcasting manner is such that the network delivers a data package to each host in the sub-network no matter whether these hosts are willing to receive the data packages. The broadcasting is only effective in the local sub-network, and the broadcast transmission is controlled through the router and network device.

Therefore, the master control device and the selected playing device are communicated with each other in a broadcasting manner after the connection is established. After the selected playing device sends the first broadcasting message, the master control device may receive the first broadcasting message, wherein the first broadcasting message includes the program information that is currently displayed on the connected playing device. The connected playing device will not generate the first broadcasting message until it is determined that the display feedback condition is met, for example the connected playing device receives a broadcast that is sent from the connected master control device for requesting to acquire the currently displayed program information of the playing device, or the connected playing device receives a notification that there is a change for the program information that is broadcast by the playing device itself.

Step S106, displaying on the master control device the program information that is currently displayed on the connected playing device.

The program information that is included in the first broadcasting message and is currently displayed on the connected playing device is acquired, and the currently displayed program information is displayed on the master control device. The user can intuitively browse the program information that is currently displayed on the connected playing device, and can interact with the content of the program that is currently displayed on the playing device by clicking the program information, so that functions of a mobile phone as the remote controller are enriched.

In conclusion, according to the embodiment of the present disclosure, through the connection that is established between the master control device and the selected playing device, the playing device acquires the currently displayed program information to generate the first broadcasting message and sends the first broadcasting message to the connected master control device; and the master control device displays the program information that is included in the first broadcasting message and is currently displayed on the playing device after receiving the first broadcasting message. A user can interact with the content of the program that is currently displayed on the playing device by clicking the program information, so that functions of a mobile phone as the remote controller are enriched.

The embodiment of the present disclosure may be applied to a television control system, wherein the television control system includes a server, the master control device and the playing device. The playing device is controlled through the master control device, wherein the master control device is such as a mobile phone, a tablet computer and the like, and the playing device is such as an intelligent television, a set top box and the like. A multi-terminal interaction application may be installed in each of the master control device and the playing device, and the interaction between the master control device and the playing device can be realized based on the multi-terminal interaction applications. The respective multi-terminal interaction application of both the master control device and the playing device may be interacted with the server to acquire corresponding content.

Wherein, the multi-terminal interaction application at the master control device may be interacted with the server to acquire various information of a television, and may also be interacted with the multi-terminal interaction application at the playing device to realize the control on the playing device. Namely, the multi-terminal interaction applications are configured to realize data interaction between different terminals, such as a “multi-screen have a look” application, a remote controller application and the like.

### Second Embodiment

A data transmission method between a master control device and a playing device according to an embodiment of the present disclosure will be described in detail. The embodiment mainly describes a processing process at the playing device.

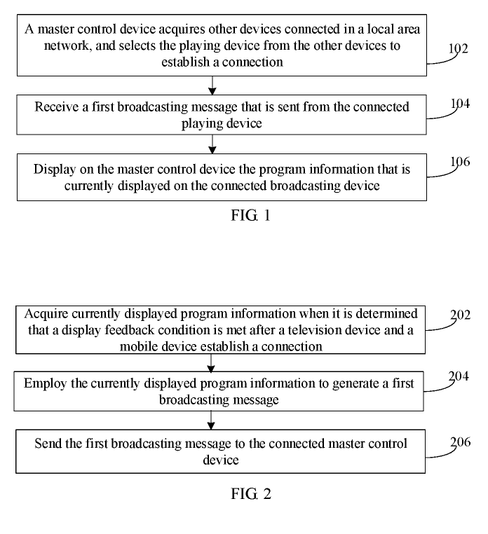

With reference to FIG. 2, which illustrates a step flowchart of realizing the data transmission method between the master control device and the playing device at the playing device according to the embodiment of the present disclosure, the data transmission method may specifically include the following steps:

Step S202, acquiring currently displayed program information when it is determined that a display feedback condition is met after the playing device and the master control device establish a connection.

When a user needs to realize a program content interaction with certain playing device through the master control device, the master control device is required to establish a connection with the playing device firstly. After the playing device and the master control device establish the connection, it is determined whether the current playing device meets the display feedback condition; if yes, the program information that is currently displayed by the playing device is acquired. The display feedback condition may include:

The playing device receives a broadcast that is sent from the connected master control device for requesting the currently displayed program information of the playing device, or the playing device receives a notification that there is a change for the program information that is broadcast by the playing device itself, wherein the notification may be sent by a multi-terminal interaction application of the playing device, such as a “multi-screen have a look” application at a television.

Step S204, employing the currently displayed program information to generate a first broadcasting message.

After the program information that is currently displayed by the playing device is acquired, the program information is sent to the connected master control device. One piece of playing device is in connection with at least one master control device, the broadcast can realize one-to-many communication among device, and therefore transmission of the program information to the connected master control device is realized by employing the currently displayed program information to generate the first broadcasting message.

Step S206, sending the first broadcasting message to the connected master control device.

The generated first broadcasting message is sent to the connected master control device in a broadcast communication manner.

In conclusion, according to the embodiment of the present disclosure, through the connection that is established between the master control device and selected playing device, the playing device acquires the currently displayed program information to generate the first broadcasting message and sends the first broadcasting message to the connected master control device; and the master control device displays the program information that is included in the first broadcasting message and is currently displayed on the playing device after receiving the first broadcasting message. A user can interact with content of a program that is currently displayed on the playing device by clicking the program information, so that functions of a mobile phone as a remote controller are enriched.

### Third Embodiment

The above embodiments respectively describe a processing method at a master control device and at a playing device, and a data transmission method will be described as a whole.

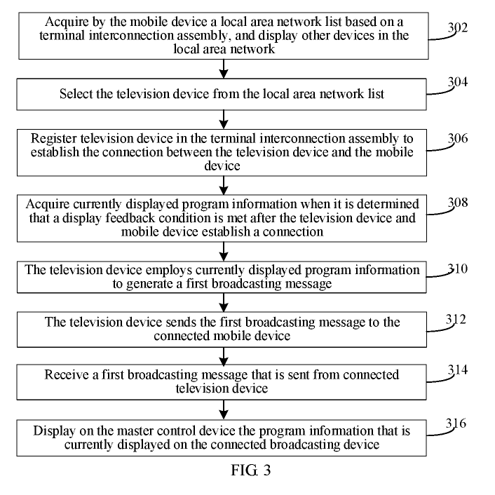

With reference to FIG. 3, which illustrates a step flowchart of realizing a data transmission method between master control device and playing device according to an embodiment of the present disclosure, the data transmission method may specifically include the steps as follows.

Step S302, the master control device acquires a local area network list based on a terminal interconnection assembly, and displays other devices in the local area network list, wherein the other devices include the playing device.

A variety of device is connected in the local area network, information such as device identification and the like of these device may be saved in the local area network list, and the master control device may acquire the local area network list based on the terminal interconnection assembly so as to display the other devices connected in the local area network, including the playing device that is connected in the local area network, wherein the terminal interconnection assembly refers to an assembly that is generated based on a DLNA Framework (Digital Living Network Alliance Framework) to solve the problem of interconnection and intercommunication between a wireless network and a wired network including the other devices such as the master control device, the playing device and the like, so that digital media and content service may realize more sharing and increases. The terminal interconnection assembly follows a protocol that is regulated by the DLNA Framework.

Step S304, selecting the playing device from the local area network list.

The playing device that a user needs to interact with is selected from the local area network list in which all other devices connected in the local area network are displayed.

Step S306, registering the playing device in the terminal interconnection assembly to establish a connection between the playing device and the master control device.

Only the other devices such as the master control device, the playing device and the like that are registered in the terminal interconnection assembly can realize an interconnection and intercommunication. The selected playing device is registered in the terminal interconnection assembly and namely accepts the protocol that is regulated by the terminal interconnection assembly so as to establish the connection between the playing device and the master control device.

Step S308, acquiring currently displayed program information when it is determined that a display feedback condition is met after the playing device and the master control device establish the connection, wherein the currently displayed program information includes a program name, a broadcasting address and description information.

A communication between the playing device and the master control device can be realized through the terminal interconnection assembly after the playing device and the master control device establish the connection. The playing device determines whether to meet the display feedback condition; if yes, acquire the currently displayed program information. The currently displayed program information includes the program name, the broadcasting address and the description information. The program name includes the name of a TV series or the name of a variety show, such as Empresses in the Palace and If You Are the One. The broadcasting address includes a video broadcasting address of a network program or a broadcasting channel of a TV program, such as http://www.letv.com/ptv/vplay/1578861 html or CCTV-1 general channel. The description information refers to an introduction to content of the currently displayed program information, including actors cast, plot summary and the like. The step that the playing device determines whether to meet the display feedback condition and acquires the currently displayed program information includes the following two conditions:

One condition is that the master device initiatively requests program information that is currently displayed on the connected playing device, which specifically includes a sub-step S30822, a sub-step S30824 and a sub-step S30826.

The sub-step S30822 is such that the master control device sends a second broadcasting message to the connected playing device through the terminal interconnection assembly, wherein the second broadcasting message is used to request to acquire the program information that is currently displayed on the connected playing device.

The sub-step S30824 is such that the playing device receives the second broadcasting message that is sent from the connected master control device through the terminal interconnection assembly, wherein the second broadcasting message is used to request to acquire the program information that is currently displayed on the connected playing device.

The sub-step S30826 is such that the playing device determines whether to meet the display feedback condition according to the second broadcasting message, and acquires the currently displayed program information.

A plurality of pieces of device that are registered in the terminal interconnection assembly may communicate with each other in a broadcasting manner. When needing to acquire the program information that is currently displayed on the connected playing device, the master control device may send the second broadcasting message through the terminal interconnection assembly and request to acquire the currently displayed program information from the connected playing device. After receiving the second broadcasting message, the connected playing device acquires the program information that is displayed on a related application of the current playing device when it is determined to meet the display feedback condition according to the second broadcasting message, wherein the related application of the playing device includes a TV (Television) version of a roll-broadcasting station.

The second condition is that the playing device initiatively transmits the program information after monitoring that the broadcast program information changes, including a sub-step S30842 and a sub-step S30844.

The sub-step S30842 is such that the playing device determines to meet the display feedback condition when it is monitored that the currently displayed program information changes.

The sub-step S30844 is such that the playing device acquires the currently displayed program information.

The connected playing device monitors whether the program information that is displayed on the connected playing device changes regularly or from time to time, wherein the change herein includes the change from one program channel to another program channel. If the change happens, the connected playing device determines that the display feedback condition is met, and acquires the currently displayed program information, namely changed program information.

Step S310, the connected playing device employs the currently displayed program information to generate the first broadcasting message.

Step S312, the connected playing device sends the first broadcasting message to the connected master control device.

Step S314, receiving the first broadcasting message that is sent from the connected playing device, wherein the first broadcasting message is generated when the connected playing device determines that the display feedback condition is met, and includes the program information that is currently displayed on the connected playing device.

Step S316, displaying on the master control device the program information that is currently displayed on the connected playing device.

A plurality of pieces of device that are registered in the terminal interconnection assembly may communicate with each other in a broadcasting manner. The playing device that is registered in the terminal interconnection assembly employs the currently displayed program information to generate the first broadcasting message; the playing device executes a callback interface, and namely the playing device initiatively notify a multi-terminal interaction application such as a “multi-screen have a look” application at a television when the display feedback condition is met; and the multi-terminal interaction application at the television notifies all device registered in the terminal interconnection assembly after receiving the first broadcasting message. The master control message displays on the master control device the program information that is currently displayed on the connected playing device after receiving the first broadcasting message.

In conclusion, according to the embodiment of the present disclosure, through the connection that is established between the master control device and the selected playing device, the playing device acquires the currently displayed program information to generate the first broadcasting message and sends the first broadcasting message to the connected master control device not only when the master control device initiatively requests to acquire the program information that is currently displayed on the connected playing device but also when the playing device monitors that the currently displayed program information changes; and the master control device displays the program information that is included in the first broadcasting message and is currently displayed on the playing device after receiving the first broadcasting message. The user can interact with content of a program that is currently displayed on the playing device by clicking the program information, so that a mobile phone can acquire the program information that is currently displayed on the playing device more accurately and in time.

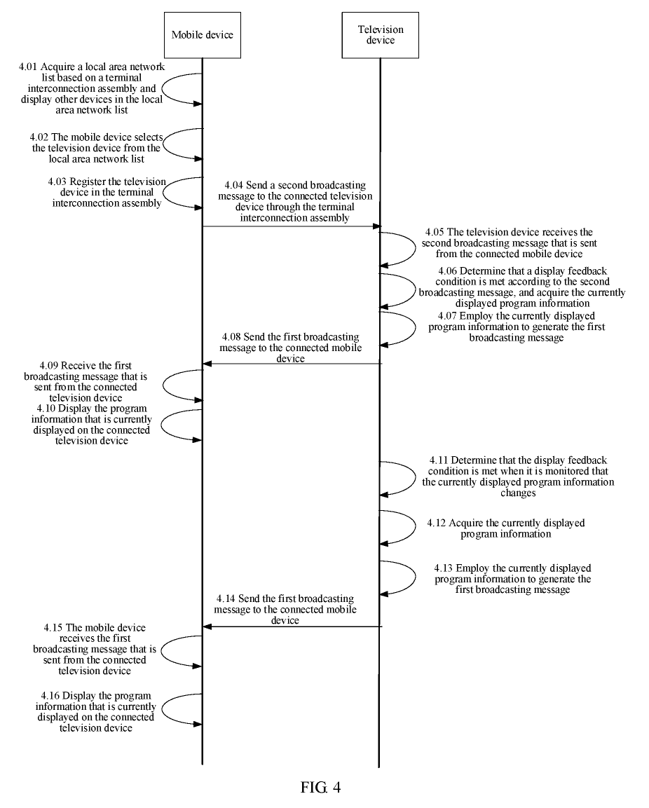

FIG. 4 illustrates a schematic diagram of a data transmission method according to the third embodiment of the present disclosure.

4.01 The master control device acquires the local area network list based on the terminal interconnection assembly and displays other devices in the local area network list.

4.02 The master control device selects the playing device from the local area network list.

4.03 The master control device registers the playing device in the terminal interconnection assembly to establish the connection between the playing device and the master control device.

4.04 The master control device sends the second broadcasting message to the connected playing device through the terminal interconnection assembly.

Wherein, the second broadcasting message is used to request to acquire the program information that is currently displayed on the connected playing device.

4.05 The playing device receives the second broadcasting message that is sent from the connected master control device through the terminal interconnection assembly.

Wherein, the second broadcasting message is used to request to acquire the program information that is currently displayed by the connected playing device.

4.06 The playing device determines that the display feedback condition is met according to the second broadcasting message, and acquires the currently displayed program information.

4.07 The playing device employs the currently displayed program information to generate the first broadcasting message.

4.08 The playing device sends the first broadcasting message to the connected master control device.

4.09 Receive the first broadcasting message that is sent from the connected playing device.

4.10 Display on the master control device the program information that is currently displayed on the connected playing device.

4.11 The playing device determines that the display feedback condition is met when it is monitored that the currently displayed program information changes.

4.12 The playing device acquires the currently displayed program information.

4.13 The playing device employs the currently displayed program information to generate the first broadcasting message.

4.14 The playing device sends the first broadcasting message to the connected master control device.

4.15 The master control device receives the first broadcasting message that is sent from the connected playing device.

4.16 Display on the master control device the program information that is currently displayed on the connected playing device.

It should be noted that: for the purpose of brief description, method embodiments are described as the combination of a series of actions, but a person skilled in the art should know that the embodiments of the present disclosure are not limited to the order of the described actions, because some steps may be executed in other order or at the same time according to the embodiments of the present disclosure. Furthermore, a person skilled in the art should also know that all the embodiments described in the specifications belong to at least one embodiment, and therefore related actions are not always necessary for the embodiments of the present disclosure.

### Fourth Embodiment

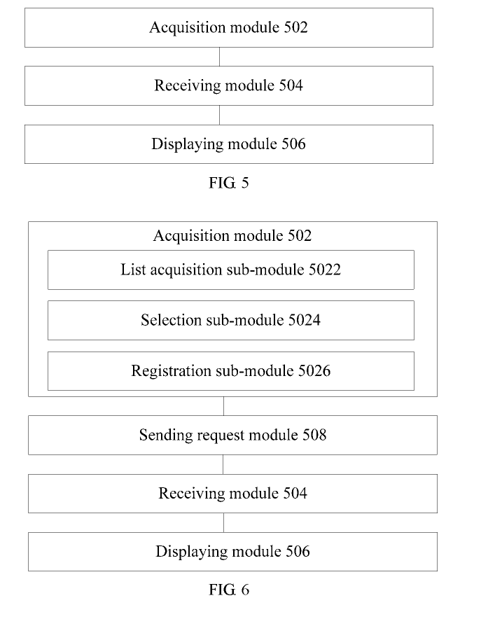

With reference to FIG. 5, which illustrates a structural block diagram of a master control device according to the fourth embodiment of the present disclosure, the master control device may specifically include the following modules:

an acquisition module 502, a receiving module 504 and a displaying module 506.

Functions of the respective modules and relationship of the modules will be described herein below separately.

The acquisition module 502 is configured to acquire other devices connected in a local area network and select playing device from the other devices to establish a connection.

The receiving module 504 is configured to receive a first broadcasting message that is sent from the connected playing device, wherein the first broadcasting message is generated when the connected playing device determines that a display feedback condition is met, and includes program information that is currently displayed on the connected playing device.

The displaying module 506 is configured to display the program information that is currently displayed on the connected playing device.

In conclusion, according to the embodiment of the present disclosure, through the connection that is established between the master control device and the selected playing device, the playing device acquires the currently displayed program information to generate the first broadcasting message and sends the first broadcasting message to the connected master control device; and the master control device displays the program information that is included in the first broadcasting message and is currently displayed on the playing device after receiving the first broadcasting message. A user can interact with content of a program that is currently displayed on the playing device by clicking the program information, so that functions of a mobile phone as the remote controller are enriched.

With reference to FIG. 6, which illustrates a structural block diagram of another master control device according to the fourth embodiment of the present disclosure, the master control device may specifically include the following modules:

the acquisition module 502, a sending request module 508, the receiving module 504 and the displaying module 506.

Functions of the respective modules and relationship of the modules will be described herein below separately.

The acquisition module 502 is configured to acquire other devices connected in the local area network and select the playing device from the other devices to establish the connection.

According to an optional embodiment of the present disclosure, the acquisition module 502 includes a list acquisition sub-module 5022, a selection sub-module 5024 and a registration sub-module 5026.

The list acquisition sub-module 5022 is configured to acquire a local area network list based on a terminal interconnection assembly and display the other devices in the local area network list, wherein the other devices include the playing device.

The selection sub-module 5024 is configured to select the playing device from the local area network list.

The registration sub-module 5026 is configured to register the playing device in the terminal interconnection assembly to establish the connection between the playing device and the master control device.

The sending request module 508 is configured to send a second message to the connected playing device through the terminal interconnection assembly, wherein the second broadcasting message is used to request to acquire the program information that is currently displayed on the connected playing device.

The receiving module 504 is configured to receive the first broadcasting message that is sent from the connected playing device, wherein the first broadcasting message is generated when the connected playing device determines that the display feedback condition is met, and includes the program information that is currently displayed on the connected playing device.

The displaying module 506 is configured to display the program information that is currently displayed on the connected playing device.

In conclusion, according to the embodiment of the present disclosure, through the connection that is established between the master control device and the selected playing device, the playing device acquires the currently displayed program information to generate the first broadcasting message and sends the first broadcasting message to the connected master control device not only when the master control device initiatively requests to acquire the program information that is currently displayed on the connected playing device but also when the playing device monitors that the currently displayed program information changes; and the master control device displays the program information that is included in the first broadcasting message and is currently displayed on the playing device after receiving the first broadcasting message. The user can interact with content of the program that is currently displayed on the playing device by clicking the program information, so that a mobile phone can acquire the program information that is currently displayed on the playing device more accurately and in time.

### Fifth Embodiment

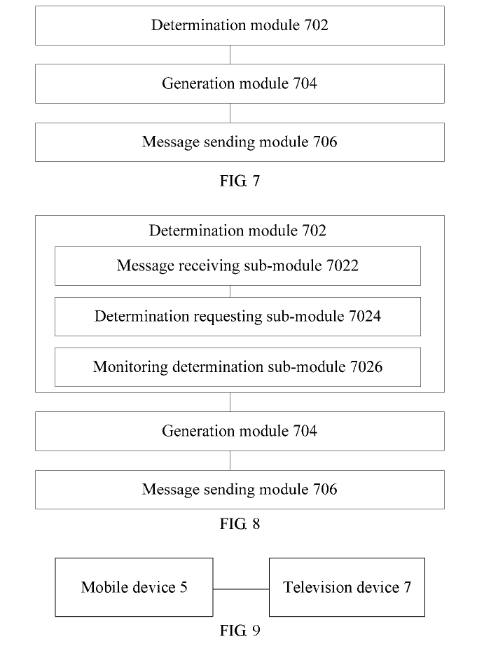

With reference to FIG. 7, which illustrates a structural block diagram of playing device according to the fifth embodiment of the present disclosure, the playing device may specifically include the modules of: a determination module 702, a generation module 704 and a message sending module 706.

Functions of the respective modules and relationship of the modules will be described herein below separately.

The determination module 702 is configured to acquire currently displayed program information when it is determined that a display feedback condition is met after establishing a connection with a master control device.

The generation module 704 is configured to employ the currently displayed program information to generate a first broadcasting message.

The message sending module 706 is configured to send the first broadcasting message to the connected master control device.

In conclusion, according to the embodiment of the present disclosure, through the connection that is established between the master control device and the selected playing device, the playing device acquires the currently displayed program information to generate the first broadcasting message and sends the first broadcasting message to the connected master control device; and the master control device displays the program information that is included in the first broadcasting message and is currently displayed on the playing device after receiving the first broadcasting message. A user can interact with content of a program that is currently displayed on the playing device by clicking the program information, so that functions of a mobile phone as the remote controller are enriched.

With reference to FIG. 8, which illustrates a structural block diagram of another playing device according to the present disclosure,

the playing device may specifically include the following modules:

the determination module 702, the generation module 704 and the message sending module 706.

The determination module 702 is configured to acquire the currently displayed program information when it is determined that the display feedback condition is met after establishing the connection with the master control device.

According to an optional embodiment of the present disclosure, the determination module 702 includes a message receiving sub-module 7022 and a determination requesting sub-module 7024, wherein:

The message receiving sub-module 7022 is configured to receive the second broadcasting message that is sent from the connected master control device through the terminal interconnection assembly, wherein the second broadcasting message is used to request to acquire the program information that is currently displayed on the connected playing device.

The determination requesting sub-module 7024 is configured to determine that the display feedback condition is met according to the second broadcasting message and acquire the currently displayed program information.

According to another optional embodiment of the present disclosure, the determination module 702 further includes a monitoring determination sub-module 7026.

The monitoring determination sub-module 7026 is configured to determine that the display feedback condition is met and acquire the currently displayed program information when it is monitored that the currently displayed program information changes.

The generation module 704 is configured to employ the currently displayed program information to generate the first broadcasting message.

The message sending module 706 is configured to send the first broadcasting message to the connected master control device.

Correspondingly, as shown in FIG. 9, an embodiment of the present disclosure also includes a television control system, which includes the master control device 5 and the playing device 7, wherein specific modules that are included in the playing device and the master control device are as described above, and these specific modules are applied to the playing device and the master control device of the television control system so as to realize the data transmission between the playing device and the master control device in the television control system.

In conclusion, according to the embodiment of the present disclosure, through the connection that is established between the master control device and the selected playing device, the playing device acquires the currently displayed program information to generate the first broadcasting message and sends the first broadcasting message to the connected master control device not only when the master control device initiatively requests to acquire the program information that is currently displayed on the connected playing device but also when the playing device monitors that the currently displayed program information changes; and the master control device displays the program information that is included in the first broadcasting message and is currently displayed on the playing device after receiving the first broadcasting message. The user can interact with content of the program that is currently displayed on the playing device by clicking the program information, so that a mobile phone can acquire the program information that is currently displayed on the playing device more accurately and in time.

Device embodiments are briefly described herein as they are substantially similar to method embodiments; please refer to the description of the method embodiments for associated parts.

All embodiments in the specifications are described in a progressive manner. Each embodiment focuses on describing the differences from other embodiments, and please refer to each other for identical or similar parts of the respective embodiments.

A person skilled in the art should understand that embodiments of the present disclosure may provide a method, a device or a computer program product. Therefore, a hardware-only embodiment, a software-only embodiment or a hardware-software combined embodiment may be employed in the present disclosure. Moreover, the embodiments of the present disclosure may employ a computer program product that is executed on one or more computer-available storage mediums (including but not limited to a magnetic disk memory, a CD-ROM (Compact Disc Read-Only Memory), an optical memory and the like) in which a computer-available program code is included.

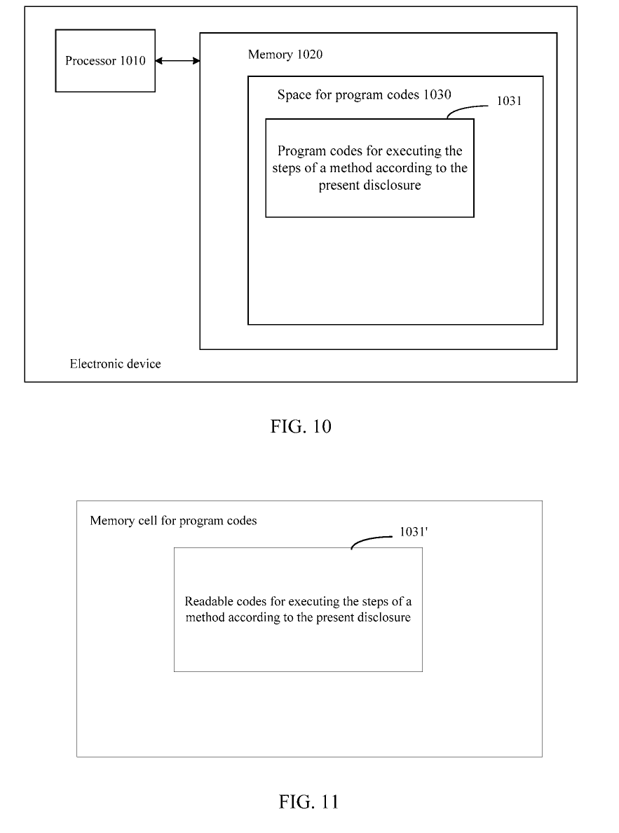

For example, FIG. 10 illustrates a block diagram of an electronic device for executing the method according the disclosure. The electronic device may be the master control device or the play device above. Traditionally, the electronic device includes a processor 1010 and a computer program product or a computer readable medium in form of a memory 1020. The memory 1020 could be electronic memories such as flash memory, EEPROM (Electrically Erasable Programmable Read-Only Memory), EPROM, hard disk or ROM. The memory 1020 has a memory space 1030 for executing program codes 1031 of any steps in the above methods. For example, the memory space 1030 for program codes may include respective program codes 1031 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 11. The memory cells may be provided with memory sections, memory spaces, etc., similar to the memory 1020 of the electronic device as shown in FIG. 10. The program codes may be compressed for example in an appropriate form. Usually, the memory cell includes computer readable codes 1031′ which can be read for example by processors 1010. When these codes are operated on the electronic device, the electronic device may execute respective steps in the method as described above.

The embodiments of the present disclosure are described with reference to flowcharts and/or block diagrams of a method, terminal device (system) and a computer program product according to the embodiment of the present disclosure. It should be understood that each flow and/or block in the flowcharts and/or the block diagrams and the combination of flows and/or blocks in the flowcharts and/or the block diagrams may be realized by computer program instructions. These computer program instructions may be provided to a general-purpose computer, a special-purpose computer, an embedded processor or other processors of programmable data processing terminal device to generate a machine, so that the instructions that are executed by the computers or other processors of the programmable data processing terminal device generate a device for realizing functions that are designated in one or more flows of the flowcharts and/or one or more blocks of the block diagrams.

These computer program instructions may also be stored a computer readable storage that can guide a computer or other programmable data processing terminal device to work in a specific manner, so that the instructions that are stored in the computer readable storage generate a produce that includes an instructing device, and the instructing device can realize the functions that are designated in one or more flows of the flowcharts and/or one or more blocks of the block diagrams.

These computer program instructions may also be loaded to a computer or other programmable data processing terminal device, so as to execute a series of operation steps on the computer or the other programmable data processing terminal device to generate computer-realized processing, and therefore the instructions that are executed on the computer or the other programmable data processing terminal device provide steps for realizing the functions that are designated in one or more flows of the flowcharts and/or one or more blocks of the block diagrams.

Although the embodiments of the present disclosure have been described, a person skilled in the art may change or amend these embodiments in case of learning about the basic concept of creativity. Therefore, the accompanying claims are explained on purpose to include all changes and amendments within the scope of the present disclosure.

Finally, it should be noted that: the relational terms in the present disclosure, such as first, second and the like, are only employed to distinguish one entity or an operation from another entity or operation, and do not always claim or imply that there is any such actual relation or order between these entities or operations. Moreover, the term “comprise”, “include” or any other variants thereof intends to cover non-exclusive inclusions, so that a process, a method, an article or terminal device comprising a series of elements not only comprises the indicated elements but also comprises other elements that are not listed explicitly or inherent elements for the process, method, article or terminal device. In case of no further limitation, an element that is defined by the term “comprising a” does not exclude that additional identical elements also exist in the process, method, article or terminal device comprising the element.

According to the present disclosure, the data transmission method between the master control device and the playing device is described in detail. Principles and embodiments of the present disclosure are explained herein based on specific cases. The above embodiments are descriptions on the method and the core concept of the present disclosure; and meanwhile a person skilled in the art will make amendments on the embodiments and application scope thereof according to the concept of the present disclosure. In conclusion, content of the specifications should not be understood as a limitation to the present disclosure.

What is claimed:

1. A data transmission method between a master control device and a playing device, the method comprising:
acquiring, by the master control device, other devices connected in a local area network, and selecting the playing device from the other devices to establish a connection;
receiving a first broadcasting message that is sent from the connected playing device, wherein the first broadcasting message is generated when the connected playing device determines that a display feedback condition is met, and the first broadcasting message comprises program information that is currently displayed on the connected playing device; and
displaying on the master control device the program information that is currently displayed on the connected playing device.

2. The method according to claim 1, wherein acquiring, by the master control device, other devices connected in a local area network, and selecting the playing device from the other devices to establish a connection comprises:
acquiring, by the master control device, a local area network list based on a terminal interconnection assembly, and displaying the other devices in the local area network list, wherein the other devices comprises the playing device;
selecting the playing device from the local area network list; and
registering the playing device in the terminal interconnection assembly to establish the connection between the playing device and the master control device.

3. The method according to claim 2, wherein before receiving a first broadcasting message that is sent from the connected playing device, the method further comprises:
sending a second broadcasting message to the connected playing device through the terminal interconnection assembly, wherein the second broadcasting message is used to request to acquire the program information that is currently displayed on the connected playing device.

4. The method according to claim 1, wherein the currently displayed program information comprises a program name, a broadcasting address and description information.

5. A data transmission method between a master control device and a playing device, the method comprising:
acquiring currently displayed program information when it is determined that a display feedback condition is met after the playing device and the master control device establish a connection;
employing the currently displayed program information to generate a first broadcasting message; and
sending the first broadcasting message to the connected master control device.

6. The method according to claim 5, wherein acquiring the currently displayed program information when it is determined that the display feedback condition is met comprises:
receiving a second broadcasting message that is sent from the connected master control device through a terminal interconnection assembly, wherein the second broadcasting message is used to request to acquire the program information that is currently displayed by the connected playing device; and
determining that the display feedback condition is met according to the second broadcasting message, and acquiring the currently displayed program information.

7. The method according to claim 6, wherein determining that the display feedback condition is met and acquiring the currently displayed program information further comprises:
determining that the display feedback condition is met when the playing device monitors that the currently displayed program information changes; and
acquiring the currently displayed program information.

8. An electronic device, comprising:
at least one first processor; and
a first memory communicably connected with the at least one first processor for storing instructions executable by the at least one first processor, wherein execution of the instructions by the at least one first processor causes the at least one first processor to:
acquire other devices connected in a local area network and select a playing device from the other devices to establish a connection;
receive a first broadcasting message that is sent from the connected playing device, wherein the first broadcasting message is generated when the connected playing device determines that a display feedback condition is met, and the first broadcasting message comprises program information that is currently displayed on the connected playing device; and
display the program information that is currently displayed on the connected playing device.

9. The master control device according to claim 8, wherein acquire other device connected in a local area network and select playing device from the other device to establish a connection comprises:
acquire a local area network list based on a terminal interconnection assembly and display the other devices in the local area network list, wherein the other devices comprise the playing device;
select the playing device from the local area network list; and
register the playing device in the terminal interconnection assembly to establish the connection between the playing device and the master control device.

10. The master control device according to claim 9, wherein execution of the instructions by the at least one processor causes the at least one processor to further:
send a second message to the connected playing device through the terminal interconnection assembly, wherein the second broadcasting message is used to request to acquire the program information that is currently displayed on the connected playing device.

11. The master control device according to claim 8, wherein the currently displayed program information comprises a program name, a broadcasting address and description information.

12. A playing device, comprising:
at least one second processor; and
a second memory communicably connected with the at least one second processor for storing instructions executable by the at least one second processor, wherein execution of the instructions by the at least one second processor causes the at least one second processor to:
acquire currently displayed program information when it is determined that a display feedback condition is met after the electronic device and a master control device establish a connection;
employ the currently displayed program information to generate a first broadcasting message; and
send the first broadcasting message to the connected master control device.

13. The playing device according to claim 12, wherein acquire currently displayed program information when it is determined that a display feedback condition is met after the playing device and master control device establish a connection comprises:
receive a second broadcasting message that is sent from the connected master control device through a terminal interconnection assembly, wherein the second broadcasting message is used to request to acquire the program information that is currently displayed on the connected playing device; and
determine that the display feedback condition is met according to the second broadcasting message and acquire the currently displayed program information.

14. The playing device according to claim 13, wherein acquire currently displayed program information when it is determined that a display feedback condition is met after the playing device and master control device establish a connection further comprises:
determine that the display feedback condition is met and acquire the currently displayed program information when it is monitored that the currently displayed program information changes.
